(19) United States
(12) Patent Application Publication
(10) Pub. No.: US 2009/0140832 A1
(43) Pub. Date: Jun. 4, 2009

(54) Fuse device, particularly for ensuring protection of a cable harness

(76) Inventors: Heiko Frohlke, Ehrenburg (DE); Susann Jansen, Fahrenhorst (DE)

Correspondence Address: COLLARD & ROE, P.C., 1077 NORTHERN BOULEVARD, ROSLYN, NY, 11576, US

(21) Appl. No.: 10/585,545

(22) PCT Filed: Jan. 11, 2005
(86) PCT No.: PCT/DE05/00022

§ 371 Date: Jul. 10, 2006

(30) Foreign Application Priority Data
Jan. 15, 2004 (DE) 20 2004 000 526.3

(51) Int. Cl. H01H 85/165; H01H 85/04

(52) U.S. Cl. 337/187

(57) ABSTRACT

The invention relates to a safety device, in particular for ensuring protection of a loom of cables. The safety device comprises a strip fuse comprising at least two connection contacts. According to the invention, at least one connection piece is firmly arranged in an electrically conductive manner on at least one connection contact. The strip fuse and area of placement of the connection contacts and the connection piece are sealed at least in sections with the aid of an electrically insulating material. The protective device is embodied in a simple manner and can thus be produced economically.

The invention relates to a fuse device, particularly for ensuring protection of a cable harness, comprising a strip fuse that has at least two connector contacts.

Fuse devices are used in connection with electrical sinks, in order to protect these electrical sinks against overloads. Fuses are used in motor vehicles, among other things, since operation takes place at high current intensities in motor vehicles.

High currents can be conducted by way of cable bundles laid in a motor vehicle. In this connection, separate fuses are disposed ahead of the individual sinks in the motor vehicle. However, it also already has been proposed to dispose a fuse for subsequent sinks in the course of a cable bundle. For example, a main fuse for sinks connected with a cable bundle can be disposed in the cable bundle directly subsequent to a battery or a generator, by way of branches.

Such fuses are enclosed by a fuse housing in the state of the art, which housing is attached to the body of the motor vehicle, for example, by way of suitable attachment means. The housing is supposed to protect the fuse against weather influences and, at the same time, insulate it, but greater expenditure of labor is required for forming and placing the housing in the motor vehicle. Such a housing must be produced separately from the cable bundle, it must be connected with the latter, and finally, it must be anchored on the body of the motor vehicle by way of screws, for example.

The invention is based on the task of indicating a fuse device of the type stated initially, which is configured in simple manner and therefore is inexpensive to produce.

This task is accomplished, according to the invention, in that at least one connector piece is firmly set onto at least one connector contact, in electrically conductive manner, and that the strip fuse and the placement region of connector contact and connector piece are sealed and covered, at least in sections, with an electrically insulating material.

In the case of the fuse device according to the invention, there is no separate housing. According to the invention, a seal is provided for encapsulating the strip fuse and its at least one connector contact, which seal is electrically insulating.

Before the insulating seal is applied, the strip fuse and a connector piece are firmly connected with one another in electrically conductive manner. For this purpose, the connector piece is set onto at least one connector contact; preferably, connector pieces are set onto both connector contacts of the strip fuse. The seal also covers this placement region between connector contact and connector piece, subsequent loosening of the connector piece from the connector contact is not possible, and is also not provided in the case of the fuse device according to the invention. By means of the configuration according to the invention, a compact fuse device is formed from pre-finished components, namely the strip fuse and the connector contacts, with the aid of connecting the electrically conductive components and with the aid of the seal. The seal enters into a firm and permanent connection with strip fuse and connector contacts as well as connector pieces, without additional connection means having to be provided for this purpose. Furthermore, the seal can be formed in an automated method during production of the fuse device, thereby making it inexpensive to produce.

According to a first further development of the invention, it is provided that the fuse device is inserted into the course of a cable bundle and that the cable bundle and the seal have approximately equal cross-section dimensions. The fuse device according to the invention can consist of a strip fuse extended longitudinally, at the connector contacts of which two connector pieces extended longitudinally are set on, for example, in a coaxial orientation. In this way, the fuse device as a whole is configured as a component extended longitudinally, which can be inserted into the course of a cable bundle. Strip fuse and connector contacts as well as connector pieces form a segment of the cable bundle, so that the currents passed by way of the cable bundle are passed by way of the strip fuse and at least one fusible conductor disposed in the strip fuse.

Because of the preferably approximately equal cross-section dimensions of cable bundle and seal, the cross-section of the cable bundle is not significantly changed, particularly not enlarged, in the region of the fuse device according to the invention. The fuse device according to the invention can therefore be disposed at locations at which the cable bundle was previously disposed without a fuse device. In this connection, it is not necessary to fix the fuse device according to the invention in place using attachment means, particularly in a motor vehicle, since the fuse device according to the invention adapts itself to the configuration of the cable bundle and can be laid loosely, like a segment of the cable bundle. The cable bundle can be attached as usual, at regular intervals, using cable ties, for example; separate attachment of the fuse device is not necessary. Of course, it is possible that the cross-sections of cable bundle and seal deviate from one another.

Connector contact and connector piece are welded to one another, for example. They can also be soldered, riveted, or connected with one another in electrically conductive manner some other way.

The connector piece is preferably a cable bracket, so that an insulated end of the cable bundle can be connected the fuse device according to the invention by way of this cable bracket. Other components can also be provided as connector pieces, for example angled profiles or distribution profiles, which have openings for passing through bolts to fix additional cable brackets in place, for example.

Preferably, a plastic that can be cast, pressed, or injected is used as the seal material. In this connection, a thermoplastic or a duroplastic, for example, can be used as the plastic. These plastics demonstrate the required insulation and strength properties.

Finally, it is preferred, according to a further development of the invention, that it also be provided that a gasket element that surrounds the connector piece is disposed on the latter. This gasket element is particularly required if a plastic to be shaped in a mold is used to produce the seal. The components of the fuse device to be sealed are laid into this mold for casting, pressing, or injecting the plastic. The gasket elements are provided in order to prevent the exit of seal material after the mold has been closed, in the region of the connector pieces that lead out of the mold. In this connection, each gasket element an O-ring that lies closely against the connector piece. The use of the gasket elements furthermore simplifies the tool structure and therefore reduces the production costs.

At least one opening can be made in the sealing material, in order to achieve fixation of the fuse device according to the invention using a bolt, after all, in certain cases.

Exemplary embodiments of the invention, from which further inventive characteristics are evident, are shown in the drawing. This shows:

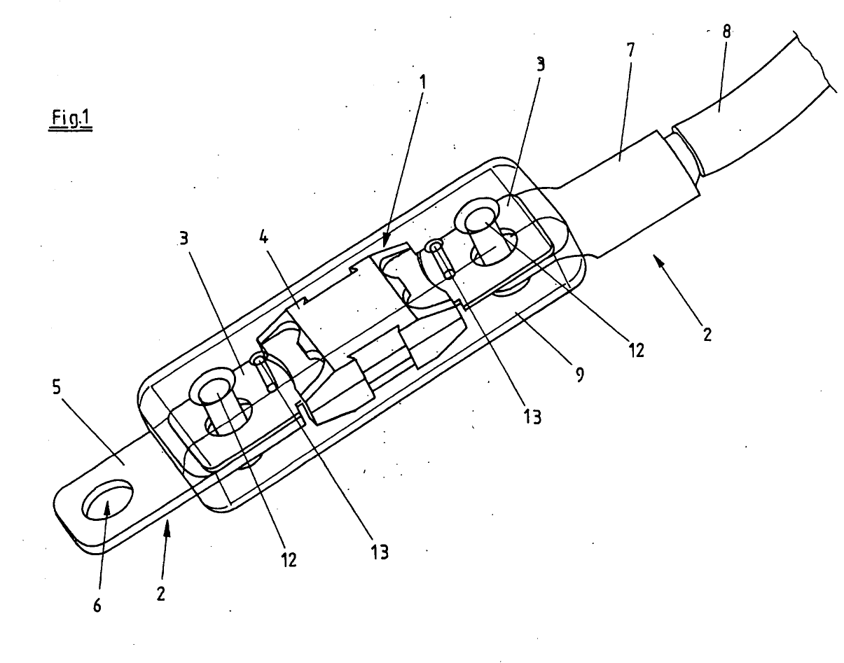

FIG. 1 a first exemplary embodiment of a fuse device according to the invention,

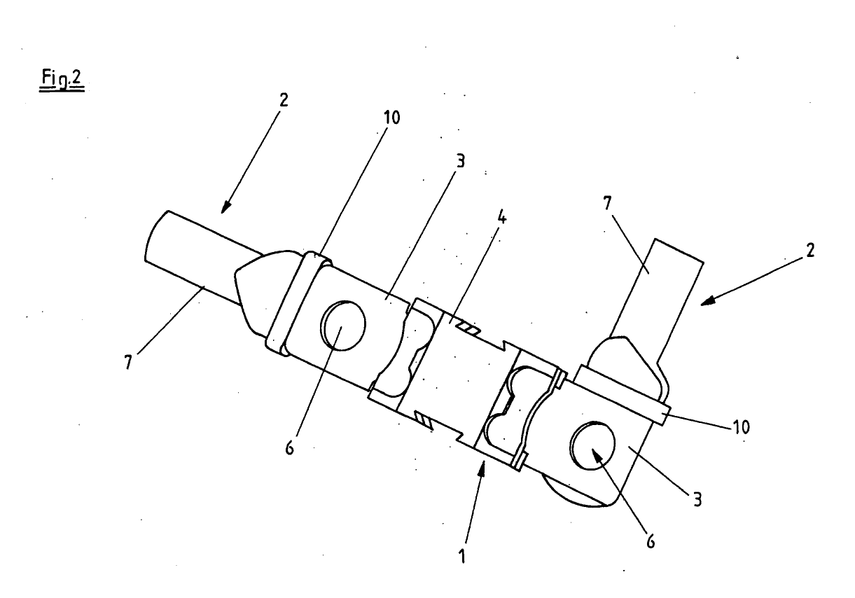

FIG. 2 a second exemplary embodiment of the fuse device according to the invention, before the seal has been applied, and

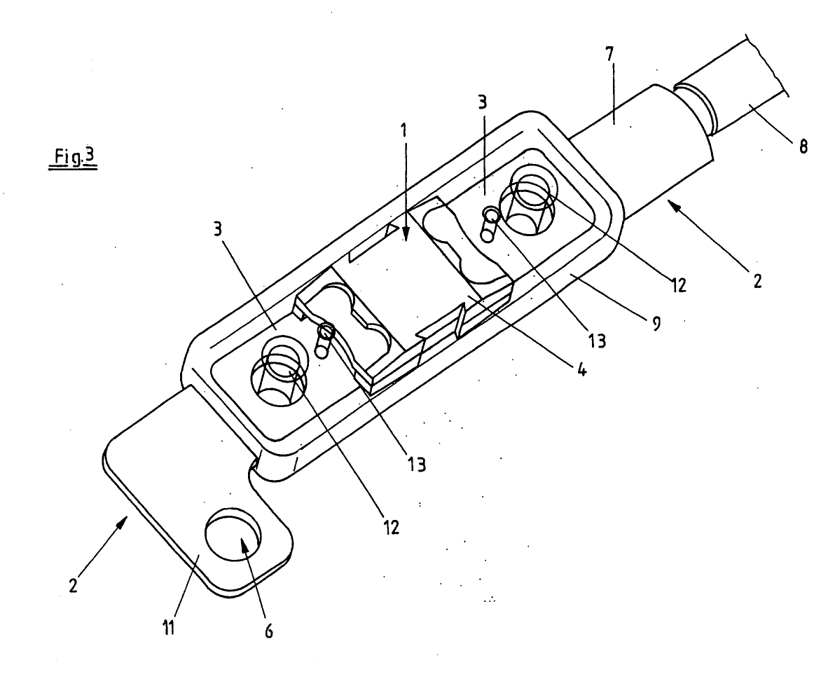

FIG. 3 a third exemplary embodiment of the fuse device according to the invention.

Each fuse device in the figures consists of a strip fuse 1 and two connector pieces 2. The strip fuse 1 has two connector contacts 3, which are connected with one another in electrically conductive manner by way of a fusible conductor disposed in a housing 4.

In FIG. 1, one connector piece 2 is configured as a flat profile 5 having an opening 6. The other connector piece 3 has a configuration as a cable bracket 7. The insulated end of a line bundle 8 is pushed into this cable bracket 7 and fixed in place in the cable bracket 7.

The connector contacts 3 and the connector pieces 2 are connected with one another in electrically conductive manner by way of welding, for example.

The strip fuse 1 with its connector contacts 3 as well as the regions of the connector pieces 2 connected with the connector contacts 3 are completely provided with a seal 9 of insulating material. The seal 9 consists of plastic, which was cast around the components to be sealed, for example. The seal 9 is fully hardened.

FIG. 2 shows the strip fuse 1 with connector pieces 2 that are configured as cable brackets 7 in both cases here, before the seal 9 is applied. One cable bracket 7 is angled out by 90° from a coaxial expanse relative to the longitudinal expanse of the strip fuse 1.

FIG. 2 shows that gasket elements configured as O-rings 10 can be disposed on the connector pieces 2. These O-rings 10 directly follow the connector contacts 3.

FIG. 3 furthermore shows that an angled flat profile 11 can also be provided as connector piece 2. Openings 12 and 13 can be made in the seal 9.

1. Fuse device, particularly for ensuring protection of a cable harness, comprising a strip fuse that has at least two connector contacts,
wherein
at least one connector piece (2) is firmly set onto at least one connector contact (3), in electrically conductive manner, and that the strip fuse (1) and the placement region of connector contact (3) and connector piece (2) are sealed and covered, at least in sections, with an electrically insulating material.

2. Fuse device according to claim 1, wherein it is inserted into the course of a cable bundle (8) and that the cable bundle (8) and the seal (9) have approximately equal cross-section dimensions.

3. Fuse device according to claim 1, wherein connector contact (3) and connector piece (2) are welded to one another.

4. Fuse device according to claim 1, wherein the connector piece (2) is a cable bracket (7).

5. Fuse device according to claim 1, wherein the connector piece (2) is an angled profile (11).

6. Fuse device according to claim 1, wherein the connector piece (2) is a distribution profile.

7. Fuse device according to claim 1, wherein the sealing material is a plastic.

8. Fuse device according to claim 7, wherein the plastic is a castable plastic.

9. Fuse device according to claim 7, wherein the plastic is a pressable plastic.

10. Fuse device according to claim 7, wherein the plastic is an injectable plastic.

11. Fuse device according to claim 7, wherein the plastic is a thermoplastic or a duroplastic.

12. Fuse device according to claim 1, wherein a gasket element that surrounds the connector piece (2) is disposed on the latter.

13. Fuse device according to claim 12, wherein the gasket element is a tightly fitting O-ring (10).

14. Fuse device according to claim 1, wherein at least one opening (12, 13) is made in the sealing material.
